(19) United States
(12) Patent Application Publication
(10) Pub. No.: US 2025/0355541 A1
(43) Pub. Date: Nov. 20, 2025

(54) INFORMATION PROCESSING METHOD AND APPARATUS, AND RELATED PRODUCTS

(71) Applicant: DOUYIN VISION CO., LTD., Beijing (CN)

(72) Inventors: Xin WANG, Beijing (CN); Hujing NIE, Beijing (CN)

(21) Appl. No.: 19/052,118

(22) Filed: Feb. 12, 2025

(30) Foreign Application Priority Data
May 16, 2024 (CN) 202410613284.5

(51) Int. Cl. G06F 3/0483; G06F 40/166

(52) U.S. Cl. CPC G06F 3/0483; G06F 40/166

(57) ABSTRACT

Embodiments of the present disclosure provide an information processing method and apparatus and related products. The method includes: displaying a reading page of a first e-book; displaying, in response to a user's content review operation aimed at the first e-book on the reading page, a content review page of the first e-book; displaying an antecedent content summary of the first e-book on the content review page. Through this embodiment, the content review page of the first e-book can be displayed, and the antecedent content summary of the first e-book can be displayed on the content review page; thereby improving the e-book reading coherence and improving the e-book reading experience.

### CROSS-REFERENCE TO RELATED APPLICATION

For all purposes, the present application claims the priority of the Chinese patent application No. 202410613284.5 filed on May 16, 2024, the entire disclosure of which is incorporated herein by reference as part of the present application.

### TECHNICAL FIELD

Embodiments of the present disclosure relate to the field of computer technology, and in particular, to an information processing method and apparatus and related products.

### BACKGROUND

At present, users often read e-books, for example, installing reading applications on their mobile phones and reading e-books in the reading applications. When a user reads an e-book in a reading application, the reading application usually shows the user the page that he/she finished reading last time. If the time interval between two readings is long, the user may forget what he/she read before, and then showing the user the page where he/she finished reading last time will reduce the e-book reading coherence and further deteriorate the e-book reading experience.

### SUMMARY

Embodiments of the present disclosure provide an information processing method and apparatus and related products, which can display a content review page of a first e-book and display an antecedent content summary of the first e-book on the content review page, thereby improving the e-book reading coherence and improving the e-book reading experience.

In a first aspect, embodiments of the present disclosure provide an information processing method, including:

displaying a reading page of a first e-book;

displaying, in response to a user's content review operation aimed at the first e-book on the reading page, a content review page of the first e-book;

displaying an antecedent content summary of the first e-book on the content review page.

In a second aspect, embodiments of the present disclosure provide an information processing apparatus, including:

a first display unit, configured to display a reading page of a first e-book;

a second display unit, configured to display, in response to a user's content review operation aimed at the first e-book on the reading page, a content review page of the first e-book;

a third display unit, configured to display an antecedent content summary of the first e-book on the content review page.

In a third aspect, embodiments of the present disclosure provide an electronic device, including: a processor; and a memory configured to store computer-executable instructions, the computer-executable instructions, when executed, cause the processor to implement the steps of the method described in the first aspect above.

In a fourth aspect, embodiments of the present disclosure provide a computer-readable storage medium, the computer-readable storage medium is configured to store computer-executable instructions, and the computer-executable instructions, when executed by a processor, implement the steps of the method described in the first aspect above.

In a fifth aspect, embodiments of the present disclosure provide a computer program product, including a computer program, and the computer program, when executed by a processor, implements the steps of the method described in the first aspect above.

In one or more embodiments, first, a reading page of the first e-book is displayed; then, a content review page of the first e-book is displayed in response to the user's content review operation aimed at the first e-book on the reading page; and finally, an antecedent content summary of the first e-book is displayed on the content review page. It can be seen that through this embodiment, the content review page of the first e-book can be displayed, and the antecedent content summary of the first e-book can be displayed on the content review page, thereby improving the e-book reading coherence and improving the e-book reading experience.

### BRIEF DESCRIPTION OF DRAWINGS

In order to explain one or more embodiments of the present disclosure or the technical solutions in the prior art more clearly, the drawings needed to be used in the description of the embodiments or the prior art will be briefly introduced below. Obviously, the drawings in the following description are only some embodiments recorded in the present disclosure, and for those skilled in the art, other drawings can be obtained according to these drawings without paying creative labor.

FIG. 1 is a schematic flowchart of an information processing method provided by an embodiment of the present disclosure;

FIG. 2 is a schematic diagram of a reading page of a first e-book provided by an embodiment of the present disclosure;

FIG. 3 is a schematic diagram of a content review page provided by an embodiment of the present disclosure;

FIG. 4 is a schematic diagram of a content review page provided by another embodiment of the present disclosure;

FIG. 5 is a schematic diagram of a content review page provided by further another embodiment of the present disclosure;

FIG. 6 is a schematic diagram of interaction with a second digital assistant provided by an embodiment of the present disclosure;

FIG. 7 is a schematic diagram of a content review page provided by still another embodiment of the present disclosure;

FIG. 8 is a schematic diagram of interaction with a second digital assistant provided by another embodiment of the present disclosure;

FIG. 9 is a schematic structural diagram of an information processing apparatus provided by an embodiment of the present disclosure; and

FIG. 10 is a schematic structural diagram of an electronic device provided by an embodiment of the present disclosure.

### DETAILED DESCRIPTION

In order to make those skilled in the art better understand the technical solutions in one or more embodiments of the present disclosure, the technical solutions in one or more embodiments of the present disclosure will be described clearly and fully below in combination with drawings in one or more embodiments of the present disclosure. It is apparent that the described embodiments are merely part of embodiments of the present disclosure rather than all embodiments. Other embodiments achieved by those skilled in the art based on the embodiments in the present disclosure without paying creative work shall fall into the scope of protection of the present disclosure.

It is to be understood that before using technical solutions disclosed in various embodiments of the present disclosure, a user should be notified of the type, scope of use, use scene and the like of personal information involved in the present disclosure in an appropriate manner according to relevant laws and regulations, and authorization from the user should be acquired.

For example, in response to receiving an active request from a user, prompt information is sent to the user to explicitly remind the user that the requested operation requires acquisition and use of personal information of the user. Therefore, the user can independently choose, according to the prompt information, whether to provide personal information to software or hardware, such as an electronic device, an application program, a server, or a storage medium, etc., for executing operations of the technical solution of the present disclosure.

In an optional but non-limiting embodiment, in response to receiving the active request from the user, the manner in which the prompt information is sent to the user may be, for example, in the form of a pop-up window in which the prompt information may be presented in text. Additionally, the pop-up window may also carry a selection control for the user to select “agree” or “disagree” to determine whether to provide personal information to the electronic device or not.

It is to be understood that the preceding process of notifying the user and obtaining authorization from the user is illustrative only and does not limit the embodiments of the present disclosure, and that other manners complying with relevant laws and regulations may also be applied to the embodiments of the present disclosure.

An embodiment of the present disclosure provides an information processing method, which can display a content review page of a first e-book, and display an antecedent content summary of the first e-book on the content review page, thereby improving the e-book reading coherence and improving the e-book reading experience. The information processing method in the embodiment of the present disclosure can be applied to and executed by a terminal device, and the terminal device includes but is not limited to a mobile phone, a computer, a tablet computer, a laptop computer, a vehicle-mounted computer, a wearable device, a virtual reality (VR) device or any other electronic device.

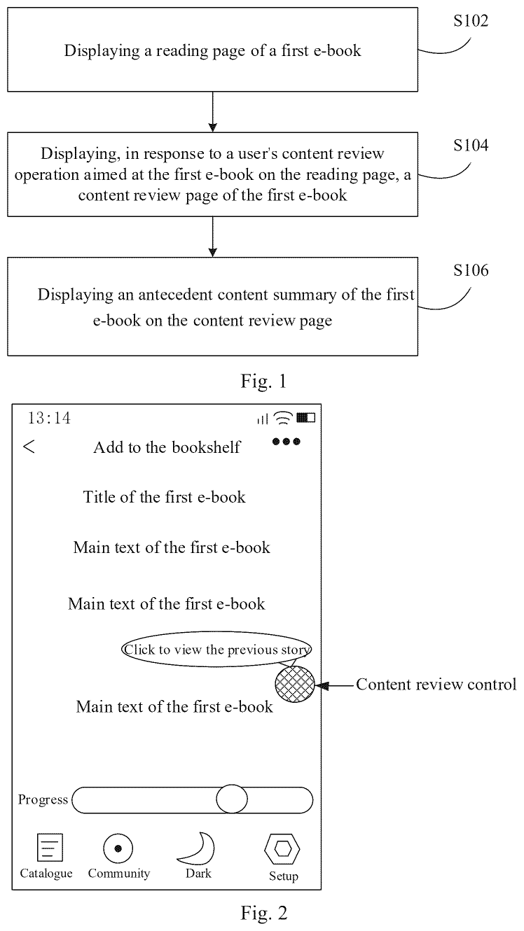

FIG. 1 is a schematic flowchart of an information processing method provided by an embodiment of the present disclosure. As shown in FIG. 1, the method includes the following steps.

Step S102: Displaying a reading page of a first e-book.

Step S104: Displaying, in response to a user's content review operation aimed at the first e-book on the reading page, a content review page of the first e-book.

Step S106: Displaying an antecedent content summary of the first e-book on the content review page.

In this embodiment, first, a reading page of the first e-book is displayed; then, a content review page of the first e-book is displayed in response to the user's content review operation aimed at the first e-book on the reading page; and finally, an antecedent content summary of the first e-book is displayed on the content review page. It can be seen that through this embodiment, the content review page of the first e-book can be displayed, and the antecedent content summary of the first e-book can be displayed on the content review page, thereby improving the e-book reading coherence and improving the e-book reading experience.

In step S102, a reading page of the first e-book is displayed. In this embodiment, the reading page of the first e-book can be displayed on a terminal device in response to the user's reading operation aimed at the first e-book. For example, in response to the user's reading operation aimed at the first e-book in a reading application program installed on the terminal device, the reading page of the first e-book can be displayed in the reading application program. The first e-book can be an e-book of any type, which is not limited here.

FIG. 2 is a schematic diagram of a reading page of a first e-book provided by an embodiment of the present disclosure. As shown in FIG. 2, the reading page of the first e-book can be displayed on the terminal device. The first e-book can be an e-book with a previous reading time of the user exceeding a time threshold from the current time. For example, the first e-book is an e-book with a previous reading time of the user exceeding 72 hours from the current time. The reading page of the first e-book is used to display the content of the first e-book that the user finished reading previously. That is, the reading page of the first e-book is the page that the user finished reading last time, thus facilitating continue reading of the first e-book for the user. In this embodiment, every operation of the user opening the first e-book can be regarded as an operation of reading the first e-book, so as to determine the time when the user read the first e-book previously, and determine the page that the user finished reading last time as the reading page.

In step S104, the content review page of the first e-book is displayed in response to the user's content review operation aimed at the first e-book on the reading page.

In an embodiment, a content review control of the first e-book is displayed on the reading page, and the displaying, in response to a user's content review operation aimed at the first e-book on the reading page, a content review page of the first e-book, includes:

displaying, in response to the user's triggering operation on the content review control, the content review page of the first e-book.

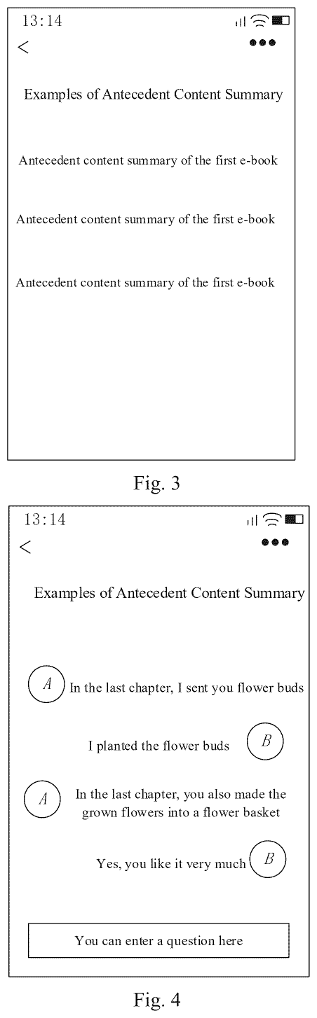

As shown in FIG. 2, a content review control of the first e-book is displayed on the reading page, for example, the circle in FIG. 2. The content review control is further configured with a prompt, such as “Click to view the antecedent story”. When the user triggers the content review control, it can jump to the content review page. Therefore, in this embodiment, in response to the user's triggering operation on the content review control, it jumps to the content review page of the first e-book. FIG. 3 is a schematic diagram of a content review page provided by an embodiment of the present disclosure. As shown in FIG. 3, an antecedent content summary of the first e-book can be displayed on the content review page.

It can be seen that through this embodiment, the content review control of the first e-book can be displayed on the reading page, and the content review page of the first e-book can be displayed in response to the user's triggering operation on the content review control, thus improving the convenience for the user to enter the content review page.

Of course, in other examples, the terminal device can also respond to a voice input instruction of the user and display the content review page of the first e-book in response to the voice input instruction when the voice input instruction indicates that the user requests to display the content review page of the first e-book.

In step S106, the antecedent content summary of the first e-book is displayed on the content review page. In an embodiment, the displaying an antecedent content summary of the first e-book on the content review page includes at least one of the following ways:

displaying an antecedent content summary related to at least one character in the first e-book on the content review page;

displaying an antecedent content summary related to at least one content plot in the first e-book on the content review page;

displaying an antecedent content summary about relationships between multiple characters in the first e-book on the content review page.

In this embodiment, the antecedent content summary of the first e-book can be displayed on the content review page in at least one of the above ways.

In one case, an antecedent content summary related to at least one character in the first e-book is displayed on the content review page. For example, an antecedent content summary related to the protagonist in the first e-book is displayed on the content review page. For another example, an antecedent content summary related to a popular character in the first e-book is displayed on the content review page, and the popular character can be determined among the characters according to the comments of readers of the first e-book on each character in the first e-book.

In another case, an antecedent content summary related to at least one content plot in the first e-book is displayed on the content review page. For example, an antecedent content summary related to a key content plot in the first e-book is displayed on the content review page, and the key content plot includes at least one of a content plot with high popularity and a content plot with great influence on the plot progress, and the popularity of a content plot can be determined according to the number of readers reading the content plot and/or the number of comments on the content plot, and whether a content plot has a great influence on the plot progress can be specified by the author and/or readers of the first e-book.

In further another case, an antecedent content summary about relationships between multiple characters in the first e-book is displayed on the content review page. For example, an antecedent content summary about character relationships and/or story relationships between multiple popular characters in the first e-book is displayed on the content review page, and the popular characters can be determined among the characters according to the comments of readers of the first e-book on each character in the first e-book, the character relationships between the popular characters includes kinship relationships, friend relationships, lover relationships or the like, and the story relationships between the popular characters include stories, conflicts, disputes or the like between the popular characters.

It can be seen that through this embodiment, one or more kinds of antecedent content summaries can be displayed on the content review page from the perspective of the character dimension, the content plot dimension, and the dimension of relationships between the character, so as to facilitate obtaining of the required information for the user, and improve the efficiency and reading experience of the user reading the first e-book.

In step S106, the antecedent content summary of the first e-book is displayed on the content review page. In an embodiment, the displaying an antecedent content summary of the first e-book on the content review page includes at least one of the following ways:

displaying the antecedent content summary in a form of text on the content review page;

displaying the antecedent content summary in a form of video on the content review page, the antecedent content summary being represented by character dialogue in the video;

displaying the antecedent content summary in a form of video on the content review page, the antecedent content summary being represented by narration of the video;

displaying first digital assistants corresponding to characters in the first e-book on the content review page, and displaying the antecedent content summary through a dialogue between the first digital assistants.

In this embodiment, the antecedent content summary of the first e-book can be displayed on the content review page in at least one of the above ways.

In one case, referring to FIG. 3, an antecedent content summary in the form of text is displayed on the content review page, that is, the antecedent content summary is displayed in the form of text.

In another case, an antecedent content summary in the form of video is displayed on the content review page, that is, the antecedent content summary is displayed in the form of video. The video can be a short video, in which multiple characters in the first e-book are displayed and a dialogue is carried out among these characters, and the antecedent content summary of the first e-book is expressed through the dialogue. To put it simply, a short video in the form of a short play is displayed on the content review page, and the antecedent content summary of the first e-book is interpreted by the characters in the short video.

In further another case, an antecedent content summary in the form of video is displayed on the content review page, that is, the antecedent content summary is displayed in the form of video. The video can be a short video, in which the characters in the first e-book are not displayed in the short video; the video content of the short video can be images related to the antecedent content summary of the first e-book, and the short video has narration, which is used to tell the antecedent content summary of the first e-book in cooperation with the video content of the short video. To put it simply, a short video in the form of narration is displayed on the content review page, and the antecedent content summary of the first e-book is described by using the images of the short video and the narration of the short video.

In still another case, first digital assistants corresponding to the characters in the first e-book are displayed on the content review page, and the antecedent content summary is displayed through a dialogue between the first digital assistants. FIG. 4 is a schematic diagram of a content review page provided by another embodiment of the present disclosure. As shown in FIG. 4, first digital assistants corresponding to multiple characters in the first e-book are displayed on the content review page. In FIG. 4, two characters, A and B, are taken as an example for illustration. Each character corresponds to one first digital assistant, and the first digital assistant can be a chatting robot generated based on a large language model. As shown in FIG. 4, on the content review page, a dialogue between the first digital assistants corresponding to respective characters is displayed, and the antecedent content summary is displayed through this dialogue. Of course, based on the characteristics of the chatting robots, the user can further choose the first digital assistant corresponding to any character on the content review page to have a dialogue with and learn more about the character.

It can be seen that, through this embodiment, one or more kinds of antecedent content summaries can be displayed on the content review page in various ways, such as text, video in the form of short play, video in the form of narration, dialogue between digital assistants corresponding to different characters, etc., so as to facilitate obtaining of the required information for the user, and improve the efficiency and reading experience of the user reading the first e-book.

In an embodiment, the displaying the antecedent content summary in a form of text on the content review page includes:

displaying the antecedent content summary sent by a second digital assistant corresponding to the first e-book in a form of dialogue on the content review page, the antecedent content summary being in the form of text.

In this embodiment, a second digital assistant corresponding to the first e-book is displayed on the content review page, and the second digital assistant is also a chatting robot generated based on a large language model. The second digital assistant can be a digital assistant representing the first e-book itself or a digital assistant representing a character in the first e-book.

In the case where the second digital assistant is used to represent a character in the first e-book and the character represented by the second digital assistant is the same as that represented by the first digital assistant, the second digital assistant is also the same as the first digital assistant. Furthermore, the antecedent content summary sent by the second digital assistant to the user in the form of dialogue is displayed on the content review page in the form of text.

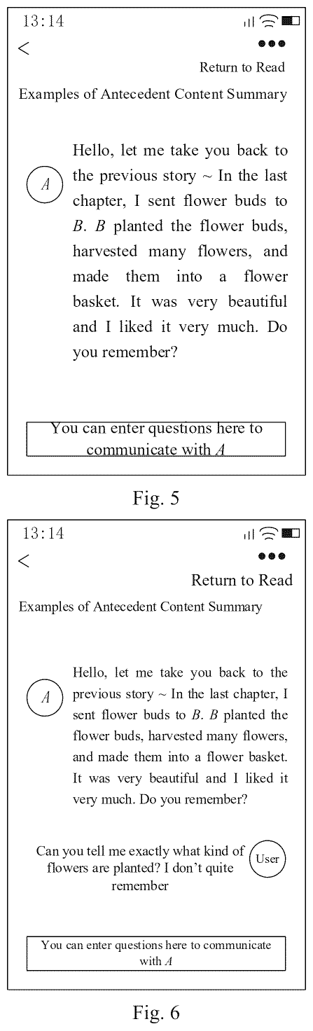

FIG. 5 is a schematic diagram of a content review page provided by further another embodiment of the present disclosure. As shown in FIG. 5, a second digital assistant corresponding to the first e-book is displayed on the content review page, and the second digital assistant is shown as a circle in FIG. 5. It is taken as an example in FIG. 5 that the second digital assistant represents a character in the first e-book. FIG. 5 further shows an antecedent content summary in the form of text, which is sent to the user by the second digital assistant in the form of dialogue. Of course, the user can further chat with the second digital assistant to get more information.

It can be seen that, through this embodiment, the antecedent content summary in the form of text, which is sent by the second digital assistant corresponding to the first e-book in the form of dialogue, can be displayed on the content review page, which is convenient for the users to quickly obtain of the antecedent content summary and improve the efficiency of the user reading the first e-book.

In an embodiment, the displaying the antecedent content summary sent by a second digital assistant corresponding to the first e-book in a form of dialogue on the content review page includes:

displaying a content summary of a first designated chapter of the first e-book sent by the second digital assistant in the form of dialogue on the content review page;

taking the content summary of the first designated chapter as the antecedent content summary, the first designated chapter including one or more chapters previously read by the user.

In this embodiment, a second digital assistant is displayed on the content review page, and a content summary of the first designated chapter of the first e-book sent by the second digital assistant in the form of dialogue is displayed, and the content summary of the first designated chapter is taken as the antecedent content summary. The first designated chapter includes one or more chapters of the first e-book previously read by the user.

It can be seen that through this embodiment, the content summary of the chapters that the user has read in history can be sent by the second digital assistant in the form of dialogue and be taken as the antecedent content summary, thus facilitating quick obtaining of the antecedent content summary for the user and improving the efficiency of the user reading the first e-book.

In an embodiment, the content summary of the first designated chapter is obtained by summarizing content of the first designated chapter with a character in the first designated chapter as a first person. For example, the content summary of the first designated chapter is obtained by summarizing content of the first designated chapter with a popular character in the first designated chapter as the first person. In this case, in order to facilitate understanding of the content summary of the first designated chapter for the user, the second digital assistant can be set to represent the popular character in the first designated chapter. On this basis, the content summary of the first designated chapter is taken as the antecedent content summary, which can facilitate quick understanding of the content plot of the first designated chapter for the user from the perspective of the popular character in the first designated chapter. As shown in FIG. 5, it is taken as an example that the second digital assistant represents the popular character A in the first designated chapter.

In an embodiment, the method flow further includes:

sending, in response to the user's operation of sending a first message to the second digital assistant on the content review page, the first message to the second digital assistant in the form of dialogue on the content review page, the first message being related to the first e-book;

displaying a second message returned by the second digital assistant in response to the first message in the form of dialogue on the content review page.

In this embodiment, the user can send a first message to the second digital assistant on the content review page, and in response to the user's operation of sending the first message to the second digital assistant on the content review page, the first message is sent to the second digital assistant in the form of dialogue on the content review page, and the first message is a message related to the first e-book. Then, a second message returned by the second digital assistant in response to the first message is displayed on the content review page in the form of dialogue.

It can be seen that through this embodiment, the user can have a dialogue with the second digital assistant, so as to quickly learn more about the first e-book.

In one embodiment, the first message includes at least one of the following messages:

a message requesting to summarize content of a second designated chapter of the first e-book;

an inquiry message for main text content of the first e-book;

an inquiry message for bibliographic information of the first e-book.

The second designated chapter may be a chapter same as or different from the first designated chapter. The inquiry message for the main text content of the first e-book can be exemplified by a message inquiring about the total word count of the first e-book, a message inquiring about the ending of the first e-book, or the like; and the inquiry message for the bibliographic information of the first e-book can be exemplified by a related message inquiring about the author of the first e-book.

It can be seen that through this embodiment, the user can send a variety of first messages, and the second digital assistant can return a second message to the user in the form of dialogue according to the first message, thus facilitating learning more about the first e-book for the user.

FIG. 6 is a schematic diagram of interaction with a second digital assistant provided by an embodiment of the present disclosure. Referring to FIG. 5 and FIG. 6, in the case where the second digital assistant sends, in the form of dialogue, the antecedent content summary in the form of text on the content review page, the user can interact with the second digital assistant to learn more about the first e-book.

Of course, in an embodiment, an antecedent content summary in the form of text can also be displayed on the content review page, the antecedent content summary includes the content summary of the first designated chapter of the first e-book, the first designated chapter includes one or more chapters of the first e-book previously read by the user, and the content summary of the first designated chapter is obtained by summarizing the content of the first designated chapter with a character in the first designated chapter as a first person and from the perspective of the character. On this basis, the second digital assistant corresponding to the first e-book is also displayed on the content review page. The second digital assistant can represent a character in the first designated chapter, which can be the character corresponding to the first person mentioned above, and the user can have a dialogue with the second digital assistant to obtain more information.

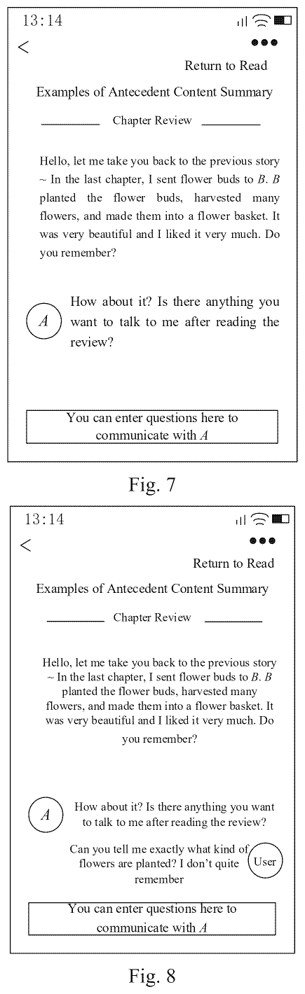

FIG. 7 is a schematic diagram of a content review page provided by still another embodiment of the present disclosure. As shown in FIG. 7, in this embodiment, an antecedent content summary in the form of text can be directly displayed on the content review page, and the second digital assistant corresponding to the first e-book can be displayed. The second digital assistant is shown as a circle in FIG. 7, and it is taken as an example that the second digital assistant represents character A in the first designated chapter. The user can have a dialogue with the second digital assistant to obtain more information.

Based on this, in this embodiment, in response to the user's operation of sending a first message to the second digital assistant on the content review page, the first message can be sent to the second digital assistant in the form of dialogue, the first message is related to the first e-book; and a second message returned by the second digital assistant in response to the first message in the form of dialogue can be displayed on the content review page. The first message includes at least one of the following messages:

a message requesting to summarize content of a second designated chapter of the first e-book;

an inquiry message for main text content of the first e-book;

an inquiry message for bibliographic information of the first e-book.

FIG. 8 is a schematic diagram of interaction with a second digital assistant provided by another embodiment of the present disclosure. Referring to FIG. 7 and FIG. 8, in the case where an antecedent content summary in the form of text is displayed on the content review page and the second digital assistant corresponding to the first e-book is also displayed thereon, the user can interact with the second digital assistant to learn more about the first e-book.

In an embodiment, it can return to the reading page of the first e-book in response to the user's request-for-reading operation aimed at the first e-book on the content review page.

In this embodiment, the user can perform a request-for-reading operation aimed at the first e-book on the content review page, and in response to the request-for-reading operation, it can return to the reading page of the first e-book to facilitate continuous reading for the user. The request-for-reading operation can be a control triggering operation, a voice input operation, or the like.

It can be seen that through this embodiment, a path is also provided to return from the content review page to the reading page of the first e-book, thus facilitating jumping between the content review page and the reading page of the first e-book for the user.

In an embodiment, a read control of the first e-book is displayed on the content review page, and the returning, in response to the user's request-for-reading operation aimed at the first e-book on the content review page, to the reading page of the first e-book includes:

returning, in response to the user's triggering operation on the read control, to the reading page of the first e-book.

Referring to FIG. 5 and FIG. 7, in this embodiment, a read control of the first e-book is displayed on the content review page, which is shown by the “Return to Read” control in FIG. 5 and FIG. 7; and the user can trigger this control, so that it returns to the reading page of the first e-book in response to the user's triggering operation on the read control.

It can be seen that through this embodiment, the user can quickly jump back to the reading page of the first e-book to continue reading with the help of the read control.

In summary, through this embodiment, the content review page of the first e-book can be displayed, and the antecedent content summary of the first e-book can be displayed on the content review page, thereby improving the e-book reading coherence and improving the e-book reading experience.

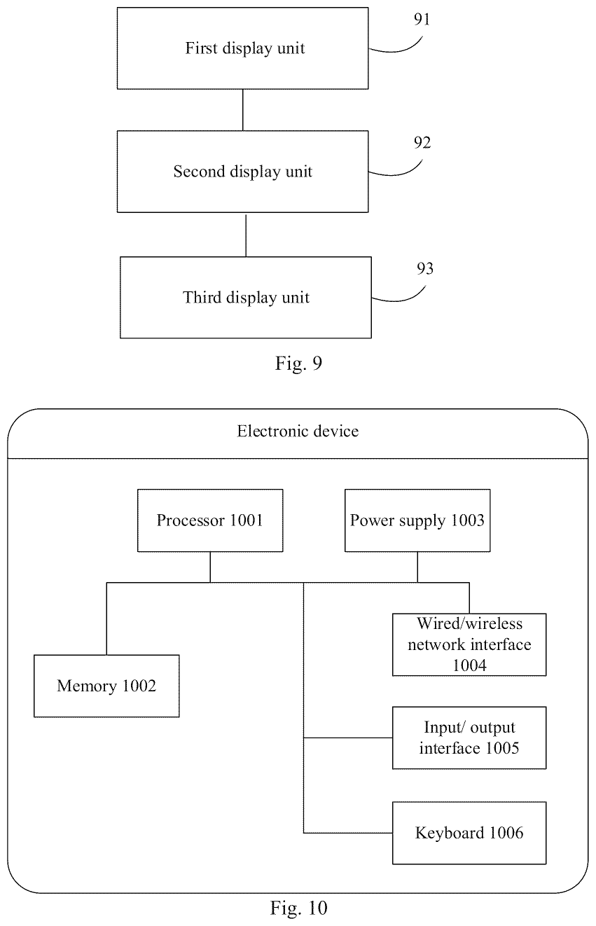

FIG. 9 is a schematic structural diagram of an information processing apparatus provided by an embodiment of the present disclosure. As shown in FIG. 9, the apparatus includes:

a first display unit 91, configured to display a reading page of a first e-book;

a second display unit 92, configured to display, in response to a user's content review operation aimed at the first e-book on the reading page, a content review page of the first e-book;

a third display unit 93, configured to display an antecedent content summary of the first e-book on the content review page.

Optionally, a content review control of the first e-book is displayed on the reading page; and the second display unit 92 is specifically configured to:

display, in response to the user's triggering operation on the content review control, the content review page of the first e-book.

Optionally, the third display unit 93 is specifically configured in at least one of the following ways to:

display an antecedent content summary related to at least one character in the first e-book on the content review page;

display an antecedent content summary related to at least one content plot in the first e-book on the content review page;

display an antecedent content summary about relationships between multiple characters in the first e-book on the content review page.

Optionally, the third display unit 93 is specifically configured in at least one of the following ways to:

display the antecedent content summary in a form of text on the content review page;

display the antecedent content summary in a form of video on the content review page, the antecedent content summary being represented by characters' dialogue in the video;

display the antecedent content summary in a form of video on the content review page, the antecedent content summary being represented by narration of the video;

display first digital assistants corresponding to characters in the first e-book on the content review page, and display the antecedent content summary through a dialogue between the first digital assistants.

Optionally, the third display unit 93 is further specifically configured to:

display the antecedent content summary sent by a second digital assistant corresponding to the first e-book in a form of dialogue on the content review page, the antecedent content summary being in the form of text.

Optionally, the third display unit 93 is further specifically configured to:

display a content summary of a first designated chapter of the first e-book sent by the second digital assistant in the form of dialogue on the content review page;

take the content summary of the first designated chapter as the antecedent content summary, the first designated chapter including one or more chapters previously read by the user.

Optionally, the content summary of the first designated chapter is obtained by summarizing content of the first designated chapter with a character in the first designated chapter as a first person.

Optionally, the apparatus further includes:

a message sending unit, configured to send, in response to the user's operation of sending a first message to the second digital assistant on the content review page, the first message to the second digital assistant in the form of dialogue on the content review page, the first message being related to the first e-book;

a message returning unit, configured to display a second message returned by the second digital assistant in response to the first message in the form of dialogue on the content review page.

Optionally, the first message includes at least one of the following messages:

a message requesting to summarize content of a second designated chapter of the first e-book;

an inquiry message for main text content of the first e-book;

an inquiry message for bibliographic information of the first e-book.

Optionally, the apparatus further includes:

a page returning unit, configured to return, in response to the user's request-for-reading operation aimed at the first e-book on the content review page, to the reading page of the first e-book.

Optionally, a read control of the first e-book is displayed on the content review page; and the page returning unit is specifically configured to:

return, in response to the user's triggering operation on the read control, to the reading page of the first e-book.

Optionally, the first e-book is an e-book with a previous reading time of the user exceeding a time threshold from a current time; the reading page is used to display content of the first e-book that the user finished reading previously.

The information processing apparatus in the embodiment of the present disclosure can implement various processes of the above-mentioned information processing method embodiments, and achieve the same effects and functions, which are not repeated here.

An embodiment of the present disclosure further provides an electronic device. FIG. 10 is a schematic structural diagram of an electronic device provided by an embodiment of the present disclosure. As shown in FIG. 10, the electronic device, which may vary greatly based on configuration or performance, can include one or more processors 1001 and a memory 1002, and one or more applications or data can be stored in the memory 1002. The memory 1002 can be a temporary storage or a permanent storage. The application program stored in the memory 1002 can include one or more modules (not shown in the figure), and each module can include a series of computer-executable instructions in an electronic device. Further, the processor 1001 can be configured to communicate with the memory 1002 and execute a series of computer-executable instructions in the memory 1002 on the electronic device. The electronic device can further include one or more power supplies 1003, one or more wired or wireless network interfaces 1004, one or more input or output interfaces 1005, one or more keyboards 1006, etc.

In a specific embodiment, the electronic device includes a processor and a memory configured to store computer-executable instructions, and the computer-executable instructions, when executed, cause the processor to implement the following processes:

displaying a reading page of a first e-book;

displaying, in response to a user's content review operation aimed at the first e-book on the reading page, a content review page of the first e-book;

displaying an antecedent content summary of the first e-book on the content review page.

The electronic device in the embodiment of the present disclosure can implement various processes of the above-mentioned information processing method embodiments, and achieve the same effects and functions, which are not repeated here.

Another embodiment of the present disclosure further provides a computer-readable storage medium, the computer-readable storage medium is configured to store computer-executable instructions, and the computer-executable instructions, when executed by a processor, implement the following processes:

displaying a reading page of a first e-book;

displaying, in response to a user's content review operation aimed at the first e-book on the reading page, a content review page of the first e-book;

displaying an antecedent content summary of the first e-book on the content review page.

The storage medium in the embodiment of the present disclosure can implement various processes of the above-mentioned information processing method embodiments, and achieve the same effects and functions, which are not repeated here.

Another embodiment of the present disclosure further provides a computer program product, the computer program product includes a computer program, and the computer program, when executed by a processor, implements the following processes:

displaying a reading page of a first e-book;

displaying, in response to a user's content review operation aimed at the first e-book on the reading page, a content review page of the first e-book;

displaying an antecedent content summary of the first e-book on the content review page.

The computer program product in the embodiment of the present disclosure can implement various processes of the above-mentioned information processing method embodiments, and achieve the same effects and functions, which are not repeated here.

In various embodiments of the present disclosure, the computer-readable storage medium includes a read-only memory (ROM), a random access memory (RAM), a magnetic disk or an optical disk, etc.

In the 1990s, whether a technical improvement is a hardware improvement (for example, an improvement to a circuit structure, such as a diode, a transistor, or a switch) or a software improvement (an improvement to a method procedure) can be clearly distinguished. However, with the development of technologies, current improvements to many method procedures can be considered as direct improvements to hardware circuit structures. Almost all designers program an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL), etc. At present, the Very-High-Speed Integrated Circuit Hardware Description Language (VHDL) and Verilog are most commonly used. It should also be clear to those skilled in the art that a hardware circuit for implementing a logical method procedure can be easily obtained by performing slight logic programming on the method procedure by using the several hardware description languages mentioned above and programming the method procedure into an integrated circuit.

A controller can be implemented by using any appropriate method. For example, the controller can be a microprocessor or a processor, and a computer-readable medium that stores computer-readable program code (e.g., software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. Those skilled in the art also know that in addition to implementing the controller by using only the computer-readable program code, logic programming can be performed on method steps to enable the controller to implement the same function in forms of the logic gate, the switch, the application-specific integrated circuit, the programmable logic controller, the built-in microcontroller, or the like. Therefore, the controller can be considered as a hardware component, and an apparatus that is configured to implement various functions and that is included in the controller can also be considered as a structure in the hardware component. Alternatively, an apparatus configured to implement various functions can even be considered as both a software module implementing the method and a structure in the hardware component.

The system, apparatus, module, or unit illustrated in the above embodiments can be specifically implemented by using a computer chip or entity, or can be implemented by using a product having a specific function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, when the embodiments of the present disclosure are implemented, functions of the units can be implemented in one or more pieces of software and/or hardware.

Those skilled in the art should understand that one or more embodiments of the present disclosure can be provided as methods, systems, or computer program products. Therefore, one or more embodiments of the present disclosure can use a form of hardware-only embodiments, software-only embodiments, or embodiments with a combination of software and hardware. Moreover, one or more embodiments of the present disclosure can use a form of a computer program product implemented on one or more computer-usable storage media (including but not limited to a magnetic disk storage, a CD-ROM, an optical storage, or the like) that include computer-usable program code.

The present disclosure is described with reference to the flowcharts and/or block diagrams of the method, the device (system), and the computer program product according to the embodiments of the present disclosure. It should be understood that computer program instructions can be used to implement each procedure and/or each block in the flowcharts and/or the block diagrams, and a combination of a procedure and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of another programmable data processing device generate an apparatus for implementing a specific function in one or more procedures in the flowcharts and/or in one or more blocks in the block diagrams.

These computer program instructions can also be stored in a computer-readable storage that can instruct a computer or another programmable data processing device to work in a specific manner, so that the instructions stored in the computer-readable storage generate an artifact that includes an instruction apparatus. The instruction apparatus implements a specific function in one or more procedures in the flowcharts and/or in one or more blocks in the block diagrams.

These computer program instructions can also be loaded onto a computer or another programmable data processing device, so that a series of operations and steps are performed on the computer or the another programmable device, to generate computer-implemented processing. Therefore, the instructions executed on the computer or the other programmable device provide steps for implementing a specific function in one or more procedures in the flowcharts and/or in one or more blocks in the block diagrams.

It is worthwhile to further note that the terms “include”, “comprise”, or any other variant thereof are intended to cover a non-exclusive inclusion, so that a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the existence of additional identical elements in the process, method, product, or device that includes the element.

One or more embodiments of the present disclosure can be described in the general context of computer-executable instructions, for example, a program module. Generally, the program module includes a routine, a program, an object, a component, a data structure, and the like for executing a specific task or implementing a specific abstract data type. Alternatively, one or more embodiments of the present disclosure can be practiced in distributed computing environments. In the distributed computing environments, tasks are performed by remote processing devices connected through a communication network. In the distributed computing environments, the program module can be located in both local and remote computer storage media including storage devices.

The embodiments of the present disclosure are described in a progressive manner. The same or similar parts between various embodiments can be referred to each other. Each embodiment focuses on a difference from other embodiments. Particularly, the system embodiments are basically similar to the method embodiments, and therefore are described briefly. For related parts, references can be made to some descriptions in the method embodiments.

The above descriptions are merely embodiments of the present disclosure, and are not intended to limit the present disclosure. Those skilled in the art can make various changes and variations to the present disclosure. Any modification, equivalent replacement, or improvement made without departing from the spirit and principle of the present disclosure shall fall within the scope of the claims of the present disclosure.

1. An information processing method, comprising:
displaying a reading page of a first e-book;
displaying, in response to a user's content review operation aimed at the first e-book on the reading page, a content review page of the first e-book;
displaying an antecedent content summary of the first e-book on the content review page.

2. The method according to claim 1, wherein a content review control of the first e-book is displayed on the reading page; the displaying, in response to a user's content review operation aimed at the first e-book on the reading page, a content review page of the first e-book, comprises:
displaying, in response to the user's triggering operation on the content review control, the content review page of the first e-book.

3. The method according to claim 1, wherein the displaying an antecedent content summary of the first e-book on the content review page comprises at least one of the following ways:
displaying an antecedent content summary related to at least one character in the first e-book on the content review page;
displaying an antecedent content summary related to at least one content plot in the first e-book on the content review page;
displaying an antecedent content summary about relationships between multiple characters in the first e-book on the content review page.

4. The method according to claim 1, wherein the displaying an antecedent content summary of the first e-book on the content review page comprises at least one of the following ways:
displaying the antecedent content summary in a form of text on the content review page;
displaying the antecedent content summary in a form of video on the content review page, wherein the antecedent content summary is represented by characters' dialogue in the video;
displaying the antecedent content summary in a form of video on the content review page, wherein the antecedent content summary is represented by narration of the video;
displaying first digital assistants corresponding to characters in the first e-book on the content review page, and displaying the antecedent content summary through a dialogue between the first digital assistants.

5. The method according to claim 4, wherein the displaying the antecedent content summary in a form of text on the content review page comprises:
displaying the antecedent content summary sent by a second digital assistant corresponding to the first e-book in a form of dialogue on the content review page, wherein the antecedent content summary is in the form of text.

6. The method according to claim 5, wherein the displaying the antecedent content summary sent by a second digital assistant corresponding to the first e-book in a form of dialogue on the content review page comprises:
displaying a content summary of a first designated chapter of the first e-book sent by the second digital assistant in the form of dialogue on the content review page;
taking the content summary of the first designated chapter as the antecedent content summary, wherein the first designated chapter comprises one or more chapters previously read by the user.

7. The method according to claim 6, wherein the content summary of the first designated chapter is obtained by summarizing content of the first designated chapter with a character in the first designated chapter as a first person.

8. The method according to claim 5, wherein the method further comprises:
sending, in response to the user's operation of sending a first message to the second digital assistant on the content review page, the first message to the second digital assistant in the form of dialogue on the content review page, wherein the first message is related to the first e-book;
displaying a second message returned by the second digital assistant in response to the first message in the form of dialogue on the content review page.

9. The method according to claim 8, wherein the first message comprises at least one of the following messages:
a message requesting to summarize content of a second designated chapter of the first e-book;
an inquiry message for main text content of the first e-book;
an inquiry message for bibliographic information of the first e-book.

10. The method according to claim 1, wherein the method further comprises:
returning, in response to the user's request-for-reading operation aimed at the first e-book on the content review page, to the reading page of the first e-book.

11. The method according to claim 10, wherein a read control of the first e-book is displayed on the content review page; the returning, in response to the user's request-for-reading operation aimed at the first e-book on the content review page, to the reading page of the first e-book, comprises:
returning, in response to the user's triggering operation on the read control, to the reading page of the first e-book.

12. The method according to claim 1, wherein the first e-book is an e-book with a previous reading time of the user exceeding a time threshold from a current time, and the reading page is used to display content of the first e-book that the user finished reading previously.

13. An electronic device, comprising:
a processor; and,
a memory configured to store computer-executable instructions, wherein the computer-executable instructions, when executed, cause the processor to implement steps of the information processing method, the information processing method comprising:
displaying a reading page of a first e-book;
displaying, in response to a user's content review operation aimed at the first e-book on the reading page, a content review page of the first e-book;
displaying an antecedent content summary of the first e-book on the content review page.

14. The electronic device according to claim 13, wherein a content review control of the first e-book is displayed on the reading page; the displaying, in response to a user's content review operation aimed at the first e-book on the reading page, a content review page of the first e-book, comprises:
displaying, in response to the user's triggering operation on the content review control, the content review page of the first e-book.

15. The electronic device according to claim 13, wherein the displaying an antecedent content summary of the first e-book on the content review page comprises at least one of the following ways:
displaying an antecedent content summary related to at least one character in the first e-book on the content review page;
displaying an antecedent content summary related to at least one content plot in the first e-book on the content review page;
displaying an antecedent content summary about relationships between multiple characters in the first e-book on the content review page.

16. The electronic device according to claim 13, wherein the displaying an antecedent content summary of the first e-book on the content review page comprises at least one of the following ways:
displaying the antecedent content summary in a form of text on the content review page;
displaying the antecedent content summary in a form of video on the content review page, wherein the antecedent content summary is represented by characters' dialogue in the video;
displaying the antecedent content summary in a form of video on the content review page, wherein the antecedent content summary is represented by narration of the video;
displaying first digital assistants corresponding to characters in the first e-book on the content review page, and displaying the antecedent content summary through a dialogue between the first digital assistants.

17. The electronic device according to claim 16, wherein the displaying the antecedent content summary in a form of text on the content review page comprises:
displaying the antecedent content summary sent by a second digital assistant corresponding to the first e-book in a form of dialogue on the content review page, wherein the antecedent content summary is in the form of text.

18. The electronic device according to claim 13, wherein the information processing method further comprises:
returning, in response to the user's request-for-reading operation aimed at the first e-book on the content review page, to the reading page of the first e-book.

19. A non-transitory computer-readable storage medium, wherein the computer-readable storage medium is configured to store computer-executable instructions, and the computer-executable instructions, when executed by a processor, implement steps of the information processing method, the information processing method comprising:
displaying a reading page of a first e-book;
displaying, in response to a user's content review operation aimed at the first e-book on the reading page, a content review page of the first e-book;
displaying an antecedent content summary of the first e-book on the content review page.

20. A computer program product, comprising a computer program, and the computer program, when executed by a processor, implements steps of the method according to claim 1.
